(19) United States
(12) Patent Application Publication
(10) Pub. No.: US 2019/0309218 A1
(43) Pub. Date: Oct. 10, 2019

(54) INHIBITION OF PRECIPITATION DURING SANDSTONE ACIDIZING

(71) Applicant: Halliburton Energy Services, Inc., Houston, TX (US)

(72) Inventors: Ravikant S. Belakshe, Pune (IN); Pratiksha Shivaji Meher, Pune (IN)

(73) Assignee: Halliburton Energy Services, Inc., Houston, TX (US)

(21) Appl. No.: 16/315,306

(22) PCT Filed: Aug. 4, 2016
(86) PCT No.: PCT/US2016/045637

§ 371 Date: Jan. 4, 2019

(51) Int. Cl. C09K 8/72; C09K 8/528; E21B 37/06; E21B 43/26

(52) U.S. Cl. CPC C09K 8/725; E21B 43/26; E21B 37/06; C09K 8/528

(57) ABSTRACT

Acidic treatment fluids and compounds for retarding formation of precipitates in acidizing operations are provided. A method may introducing an acidic treatment fluid into a subterranean formation; wherein the acidic treatment fluid comprises a carrier fluid, an acid compound, a zwitterionic compound, and an anionic compound; and wherein the acid compound interacts with the subterranean formation to dissolve acid-soluble components of the subterranean formation.

### BACKGROUND

Treatment fluids can be used in a variety of subterranean operations, including, for example, stimulation treatments, conformance treatments, hydraulic fracturing treatments, acidizing treatments, remediation treatments, scale removal treatments, scale inhibition treatments, and the like. As used herein, the terms “treatment” and/or “treating” refer to any subterranean operation that uses a fluid in conjunction with achieving an intended function and/or an intended purpose. Use of these terms herein does not imply any particular action by the fluid or any particular component thereof. As used herein, the term “treatment fluid” refers to any fluid that can be used in a subterranean operation in conjunction with an intended function and/or an intended purpose.

Treatment fluids comprising an acidic base fluid can be used in a number of subterranean operations including, for example, acidizing operations. Subterranean operations utilizing an acidic treatment fluid may be challenging in some subterranean formations (e.g., sandstone formations) due to siliceous and aluminosilicate minerals commonly encountered therein. These silicon-containing minerals can interact with the acidic base fluid to produce dissolved silicon species, which can subsequently precipitate at higher pH values (e.g., greater than about 3) as amorphous, gelatinous and/or colloidal silica. As used herein, the terms “dissolved silicon” and/or “dissolved silica” will equivalently refer to silicic acid, silanols, and other soluble silicon species. As used herein, the term “silica scale” will refer to precipitated amorphous silica, precipitated gelatinous silica, precipitated colloidal silica, and hardened crusts of amorphous silica, gelatinous silica and/or colloidal silica.

In addition to silica scale, other precipitates may also be problematic in sandstone formations. Dissolution, precipitation of insoluble fluorosilicates and aluminosilicates can still become problematic in the presence of certain metal ions. Specifically, under low pH conditions (e.g., below a pH of about 3), dissolved silicon can react with Group 1 metal ions (e.g., Na⁺ and K⁺) to produce insoluble fluorosilicates and aluminosilicates. The terms “Group 1 metal ions” and “alkali metal ions” will be used synonymously herein. Other metal ions, including Group 2 metal ions (e.g., Ca²⁺ and Mg²⁺), may also be problematic in this regard. These reactions may be exacerbated at elevated temperatures (e.g., above about 200° F.). The precipitation of insoluble fluorosilicates and aluminosilicates can block pore throats and undo the desirable permeability increase initially achieved by the acidizing operation. That is, the formation of insoluble fluorosilicates and aluminosilicates can damage the subterranean formation. In many instances, the damage produced by insoluble fluorosilicates and aluminosilicates can be more problematic than if the acidizing operation had not been conducted in the first place.

Problematic alkali metal ions or other metal ions can come from any source including, for example, the acidic treatment fluid, a component of the acidic treatment fluid, or the subterranean formation itself. For example, the carrier fluid of an acidic treatment fluid may contain some sodium or potassium ions unless costly measures (e.g., deionization), are taken to limit their presence. Alkali metal ions, in particular, are widely distributed in the environment and can be especially difficult to avoid completely when conducting a subterranean treatment operation.

### BRIEF DESCRIPTION OF THE DRAWINGS

These drawings illustrate certain aspects of some of the embodiments of the present invention, and should not be used to limit or define the invention.

FIG. 1 is an example structure of a zwitterionic phosphonated chitosan.

FIG. 2 is an example structure of an anionic carboxymethyl inulin.

FIG. 3 is a schematic illustration of example well system showing placement of a treatment fluid into a wellbore.

### DETAILED DESCRIPTION

The present disclose is directed to acidizing operations and, more particularly, to acidic treatment fluids and compounds for inhibiting formation of precipitates in acidizing operations.

Without limitation, the acidic treatment fluids and techniques disclosed herein may be used in acidizing operations performed in a variety of subterranean formations, including those containing siliceous and aluminosilicate minerals commonly encountered therein. Non-limiting examples of subterranean formations in which the acidic treatment fluids may be used include sandstone formations. While the exact composition may vary, sandstone formations may contain about 40% to about 98% sand quartz particles (e.g., silica) that may be bonded together by carbonates (e.g., calcites), aluminosilicates, and other silicates. As previously discussed, acidizing operations in these types of formations may be challenging due to formation of precipitates, such as silica scale and insoluble fluorosilicates and aluminosilicates.

To inhibit the formation of undesirable precipitates, the present disclosure provides that a combination of zwitterionic compounds and anionic compounds may be included in acidic treatment fluids for acidizing operations. Without limitation to theory, it is believed that certain groups (e.g., phosphonate, carboxylate, etc.) in the zwitterionic compounds and anionic compounds can chelate aluminum, calcium, magnesium, potassium, and sodium ions, among others, that may be generated in acidizing operations, such as those that employ hydrochloric and hydrofluoric acids. Advantageously, by chelating these metal ions, the precipitation effects due to their reaction with dissolved silicon may be inhibited. In addition, the combination the zwitterionic compounds and anionic compounds may also inhibit the formation of silica scale. By way of example, the formation of silica scale on the surface of the subterranean formation, within a particulate pack, and/or on equipment within the subterranean formation may be inhibited. Without being limited by theory, the zwitterionic compounds and/or anionic compounds may inhibit silica scale due to interaction with the dissolved silicon. By way of example, the positively charged groups on the zwitterionic compounds (e.g., amino groups on phosphonated zwitterionic chitosan) may form an ionic interaction with negatively charged silica surface. Advantageously, by combining the zwitterionic compound with an anionic compound, the zwitterionic compounds effectiveness for inhibition of silica scale may be extended as compared to use of zwitterionic compounds alone. Without being limited by theory, it is believed that the anionic compound may act to avoid entrapment of the zwitterionic compounds in the silica matrix, thus keeping the zwitterionic compound in solution and avoid agglomeration and precipitation of silica.

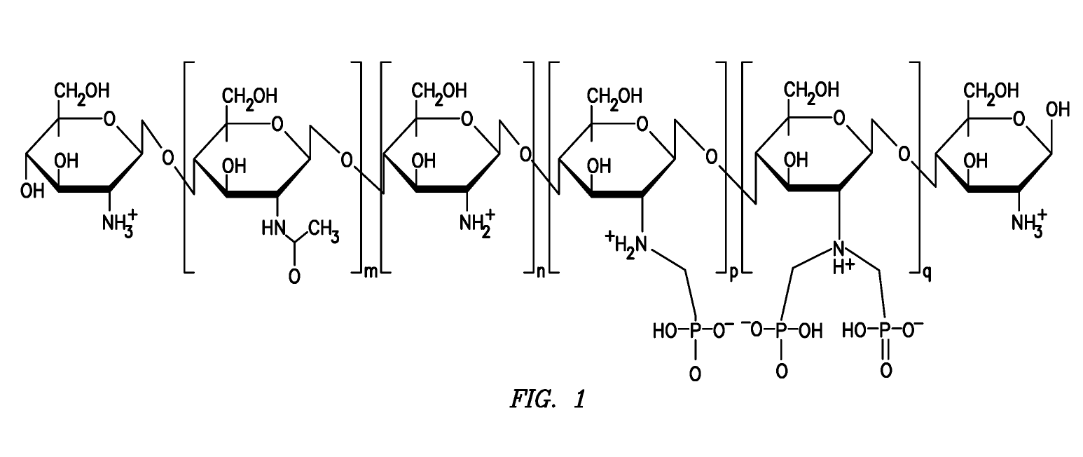

Zwitterionic compounds are compounds that are neutral with both positive and negative electrical charges. Examples of suitable zwitterionic compounds may include zwitterionic monomers, such as alanine, arginine, asparagine, aspartic acid , cysteine, glutamic acid , glutamine , glycine, histidine , isoleucine , leucine , lysine, methionine, phenylalanine , proline, serine, threonine, tryptophan, tyrosine, valine, glyphosate, phosphatidylcholine, betaine and its derivatives, or combinations thereof. Zwitterionic polymers may also be used, either alone or in combination with zwitterioinc monomers, including zwitterionic polybetaine, zwitterionic polysaccharides, or combinations thereof. Suitable zwitterionic polymers may include, for example, zwitterionic polysaccharides. Examples of suitable zwitterionic polysaccharides may include a positively charged comprising free amino moiety and a negatively charged moiety comprising a carboxylate, phosphate, phosphonate, sulfate, sulfonate, or combination thereof. The polysaccharides can be obtained from natural or synthetic sources. Particularly useful polysaccharides may include, for example, chitosan. In a specific example, the zwitterionic compound may comprise zwitterionic chitosan comprising a positively charged free amino moiety and a negatively charged moiety comprising a carboxylate, phosphate, phosphonate, sulfate, sulfonate, or combination thereof. By way of example, the zwitterionic compound may comprise zwitterionic phosphonated chitosan. An example structure for zwitterionic phosphonated chitosan is provided on FIG. 1.

Without limitation, the zwitterionic compound may be present in the acidic treatment fluids in an amount of about 1% to about 15% or about 2% to about 8% or about 2% to about 5% by weight of the acidic treatment fluids. One of ordinary skill in the art, with the benefit of this disclosure,. Should be able to choose an appropriate zwitterionic compound and amount thereof to include in a treatment fluid intended for a particular application.

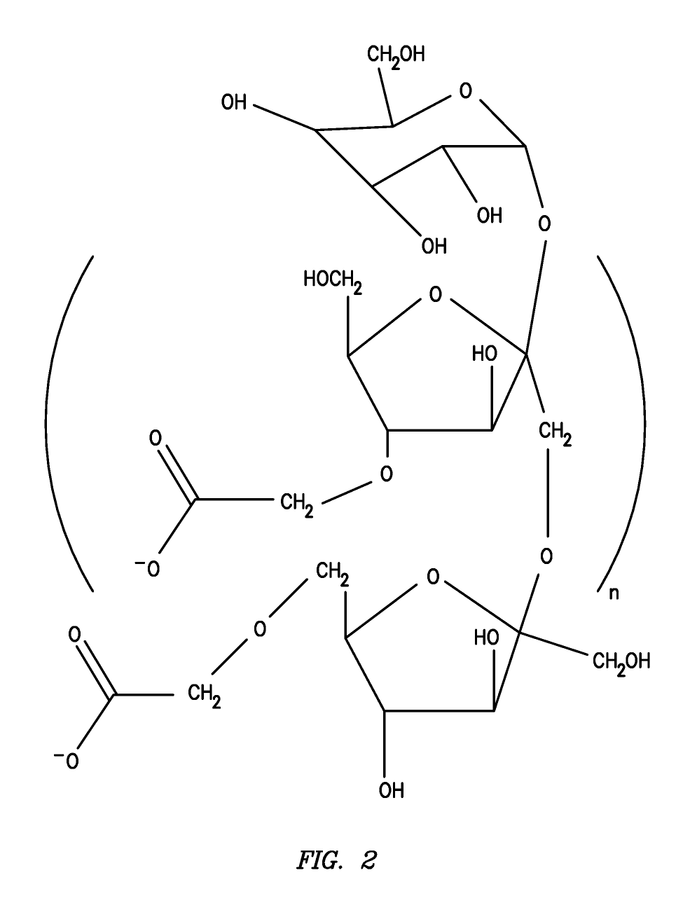

Anionic compounds are compounds that are negatively charged. Examples of suitable anionic compounds that may be used for inhibition of precipitation in acidizing operations may include, for example, organic acids, polysaccharides containing sulfate groups, anionic carboxylated polysaccharides, and polyphosphates. Combinations of suitable anionic compounds may also be used. Additional examples of suitable anionic compounds may include aminomethylphosphonic acid, vinylphosphonic acid, dimethyl methylphosphonate, 1-hydroxyethylidene-1,1-diphosphonic acid, aminotris (methylenephosphonic acid), ethylenediaminetetra (methylenephosphonic acid), tetramethylenediaminetetra (methylenephosphonic acid), hexamethylenediaminetetra (methylenephosphonic acid), diethylenetriaminepenta (methylenephosphonic acid), phosphonobutanetricarboxylic acid, N-(phosphonomethyl) iminodiacetic acid, 2-carboxyethyl phosphonic acid, 2-Hydroxyphosphonocarboxylic acid, aminotris (methylenephosphonic acid), N,N-Bis(phosphonomethyl)glycine. Examples of suitable polysaccharides containing sulfate groups may include heparin and carrageenan, among otheres. Examples of suitable organic acids may include formic acids, acetic acids, carbonic acids, citric acids, glycolic acids, lactic acids, p-toluenesulfonic acid, ethylenediaminetetraacetic acid (“EDTA”), hydroxyethyl ethylenediamine triacetic acid (“HEDTA”), and combinations thereof Examples of a suitable anionic compound may include, for example, anionic carboxylated polysaccharide, such as anionic carboxymethyl polysaccharide, anionic carboxyethyl polysaccharide, or combinations thereof. The polysaccharides can be obtained from natural or synthetic sources. Particularly useful polysaccharides are generically known as fructans. Fructan is a class of polysaccharides comprising oligomers of the monosaccharide fructose. Fructans may be readily available from natural sources and biodegradable. Examples of suitable fructans may include inulin, levan, graminin, derivatives thereof, or combinations thereof Inulins are linear fructans that may generally be linked by β(2→1) glycosidic bonds. Levans are linear fructans that may generally be linked by β(2→6) glycosidic bonds. Graminins are branched fructans that may generally be linked by both β(2→1) and β(2→6) glycosidic bonds. In a specific example, the anionic compound may comprise anionic carboxymethyl inulin, anionic carboxyethyl inulin, or combinations thereof. An example structure for anionic carboxymethyl inulin is provided on FIG. 2.

As previously mentioned, the anionic compound may be used in the acidic treatment fluids for inhibition of precipitation in combination with the zwitterionic compounds. An example of a suitable combination may include a zwitterionic chitosan and an anionic carboxylated polysaccharide. By way of further example, a combination of zwitterionic chitosan, such as zwitterionic chitosan comprising a positively charged free amino moiety and a negatively charged moiety comprising a carboxylate, phosphate, phosphonate, sulfate, sulfonate, or combination thereof, and an anionic carboxylated inulin, such as anionic carboxymethyl inulin, anionic carboxyethyl inulin, or combinations thereof, may be used in the acidic treatment fluids. In one specific example, the combination of zwitterionic phosphonated chitosan and anionic carboxymethyl inulin may be used in the acidic treatment fluids.

Without limitation, the anionic compound may be included in the acidic treatment fluids in an amount of about 0.01% to about 10% or about 2% to about 8% or about 0.01% to about 5% by weight or about 2% to about 5% by weight of the acidic treatment fluids. One of ordinary skill in the art, with the benefit of this disclosure, should be able to choose an appropriate chelating agent and amount thereof to include in a treatment fluid intended for a particular application.

The combinations of the zwitterionic compounds and anionic compounds may be mixed with the acidizing treatment fluid on the surface and then placed into the subterranean formation. The acidizing treatment fluid may further comprise a carrier fluid and an acid compound. The acidizing treatment fluid may be used to acidize the subterranean formation, for example, by dissolving acid-soluble components, such as silicates or aluminosilicates, in the subterranean formation.

The acidic treatment fluids may comprise a carrier fluid. Without limitation, the acidic treatment fluids described herein may comprise an aqueous carrier fluid as their continuous phase. Suitable aqueous carrier fluids may include, for example, fresh water, salt water, seawater, brine (e.g., a saturated salt solution), or an aqueous salt solution (e.g., a non-saturated salt solution). Aqueous carrier fluids can be obtained from any suitable source. Without limitation, the acidic treatment fluids may comprise an organic solvent, such as a hydrocarbon, as at least a portion of the carrier fluid. Suitable organic solvents may include, for example, kerosene, xylene, toulene, diesel, oils, and combinations thereof, among others.

The volume of the carrier fluid to be used in the acidic treatment fluids described herein may be dictated by certain characteristics of the subterranean formation being treated such as, for example, the quantity of the acid-soluble material needing removal, the chemistry of the acid-soluble material, and the formation porosity. Determination of an appropriate volume of carrier fluid to be used in the acidic treatment fluids may also be influenced by other factors, as will be understood by one having ordinary skill in the art.

Without limitation, the acidic treatment fluids may have a pH of about 6 or below. Use of pH values below about 6, and especially pH values of about 3 or below, may be effective for dissolving silicates and/or aluminosilicates in a siliceous formation and/or maintaining dissolved silicon in the acidic treatment fluids. By way of example, the acidic treatment fluids may have a pH ranging between about 0 and about 8, or between about 0 and about 6, or between about 0 and about 4, or between about 1 and about 6, or between about 1 and about 4, or between about 2 and about 5, or between about 0 and about 3, or between about 3 and about 6. One of ordinary skill in the art, with the benefit of this disclosure, should be able to determine an effective working pH for the acidic treatment fluids described herein.

The acidic treatment fluids may comprise an acid compound. As used herein, the term acid compound is defined to include acids, acid generating compounds, and combinations thereof. Any known acid may be suitable for use with the acidic treatment fluids. Suitable acids may include, for example, organic acids, inorganic acids, and combinations thereof. Examples of suitable organic acids may include formic acids, acetic acids, carbonic acids, citric acids, glycolic acids, lactic acids, p-toluenesulfonic acid, EDTA, HEDTA, and combinations thereof. Examples of suitable inorganic acids may include hydrochloric acid, hydrofluoric acid, phosphonic acid, phosphoric acid, fluorophosphoric acid. Without limitations, combinations of hydrochloride acid (or hydrochloric acid generating compound) and hydrofluoric acid (or hydrofluoric acid generating compounds) may be used in the acidic treatment fluids.

Suitable acid generating compounds that may be suitable for use in the acidic treatment fluids may include, for example, esters, aliphatic polyesters, ortho esters, which may also be known as ortho ethers, poly (ortho esters), which may also be known as poly(ortho ethers), poly(lactides), poly(glycolides), poly(s-caprolactones), poly(hydroxybutyrates), poly(anhydrides), or copolymers thereof. Combinations also may be suitable. The term “copolymer” as used herein is not limited to the combination of two polymers, but includes any combination of polymers, e.g., terpolymers and the like. Other suitable acid-generating compounds include esters including, but not limited to, ethylene glycol monoformate, ethylene glycol diformate, diethylene glycol diformate, glyceryl monoformate, glyceryl diformate, glyceryl triformate, triethylene glycol diformate and formate esters of pentaerythritol. Hydrofluoric acid generating compounds may be used in the acidic treatment fluids. Suitable hydrofluoric acid generating compounds may include, for example, fluoroboric acid, fluorosulfuric acid, hexafluorophosphoric acid, hexafluoroantimonic acid, difluorophosphoric acid, hexafluorosilicic acid, potassium hydrogen difluoride, sodium hydrogen difluoride, boron trifluoride acetonitrile complex, boron trifluoride acetic acid complex, boron trifluoride dimethyl ether complex, boron trifluoride diethyl ether complex, boron trifluoride dipropyl ether complex, boron trifluoride dibutyl ether complex, boron trifluoride t-butyl methyl ether complex, boron trifluoride phosphoric acid complex, boron trifluoride dihydrate, boron trifluoride methanol complex, boron trifluoride ethanol complex, boron trifluoride propanol complex, boron trifluoride isopropanol complex, boron trifluoride phenol complex, boron trifluoride propionic acid complex, boron trifluoride tetrahydrofuran complex, boron trifluoride piperidine complex, boron trifluoride ethylamine complex, boron trifluoride methylamine complex, boron trifluoride triethanolamine complex, polyvinylammonium fluoride, polyvinylpyridinium fluoride, pyridinium fluoride, imidazolium fluoride, ammonium fluoride, ammonium bifluoride, tetrafluoroborate salts, hexafluoroantimonate salts, hexafluorophosphate salts, bifluoride salts, and combinations thereof.

The acid compound may be in the acidic treatment fluids described in any suitable amount for a particular application. Without limitation, the acid compound may be present in the acidic treatment fluids in an amount ranging between about 0.1% to about 20%, or about 0.5% to about 10%, or about 0.5% to about 8% by weight of the acidic treatment fluid. One of ordinary skill in the art, with the benefit of this disclosure, should be able to select an appropriate concentration of the acid compound to be used in the acidic treatment fluids based on a number of factors, including the particular acid or combinations of acid chosen and specific composition of the formation to be treated, as well temperature.

Without limitation, the acidic treatment fluids may optionally comprise a chelating agent, in addition to the combination of zwitterionic compounds and anionic compounds. The chelating agent may be included in the treatment fluids, for example, when it is desirable to provide additional sequestration of metal ions in a subterranean formation. When present. the chelating agent may be used in an amount of about 1% to about 50% or about 3% to about 40% by weight of the acidic treatment fluids. One of ordinary skill in the art, with the benefit of this disclosure, should be able to choose an appropriate chelating agent and amount thereof to include in a treatment fluid intended for a particular application.

Examples of suitable chelating agents may be biodegradable. Although use of a biodegradable chelating agent may be particularly advantageous, there is no requirement to do so, and, in general, any suitable chelating agent may be used. As used herein, the term “biodegradable” refers to a substance that can be broken down by exposure to environmental conditions including native or non-native microbes, sunlight, air, heat, and the like. Use of the term “biodegradable” does not imply a particular degree of biodegradability, mechanism of biodegradability, or a specified biodegradation half-life.

Examples of suitable chelating agents may include common chelating agent compounds such as, for example, EDTA, propylenediaminetetraacetic acid (PDTA), nitrilotriacetic acid (NTA), HEDTA, diethylenetriaminepentaacetic acid (DTPA), hydroxyethyliminodiacetic acid (HEIDA), cyclohexylenediaminetetraacetic acid (CDTA), diphenylaminesulfonic acid (DPAS), ethylenediaminedi(o-hydroxyphenylacetic) acid (EDDHA), glucoheptonic acid, gluconic acid, citric acid, any salt thereof, any derivative thereof, and the like. It is to be noted that NTA may be considered to be a biodegradable compound, but it may have undesirable toxicity issues.

Examples of suitable chelating agents may include biodegradable chelating agents such as, for example, glutamic acid diacetic acid (GLDA), methylglycine diacetic acid (MGDA), β-alanine diacetic acid (β-ADA), ethylenediaminedisuccinic acid, S,S-ethylenediaminedisuccinic acid (EDDS), iminodisuccinic acid (IDS), hydroxyiminodisuccinic acid (HIDS), polyamino disuccinic acids, N-bis[2-(1,2-dicarboxyethoxy)ethyl]glycine (BCA6), N-bis[2-(1,2-dicarboxyethoxy)ethyl]aspartic acid (BCAS), N-bis[2-(1,2-dicarboxyethoxy)ethyl]methylglycine (MCBAS), N-tris[(1,2-dicarboxyethoxy)ethyl]amine (TCA6), N-methyliminodiacetic acid (MIDA), iminodiacetic acid (IDA), N-(2-acetamido)iminodiacetic acid (ADA), hydroxymethyl-iminodiacetic acid. 2-(2-carboxyethylamino) succinic acid (CEAA), 2-(2-carboxymethylamino) succinic acid (CMAA), diethylenetriamine-N,N″-disuccinic acid, triethylenetetramine-N,N′″-disuccinic acid, 1,6-hexamethylenediamine-N,N′-disuccinic acid, tetraethylenepentamine-N,N″″-disuccinic acid, 2-hydroxypropylene-1,3-diamine-N,N′-disuccinic acid, 1,2-propylenediamine-N,N′-disuccinic acid, 1,3-propylenediamine-N,N′-disuccinic acid, cis-cyclohexanediamine-N,N′-disuccinic acid, trans-cyclohexanediamine-N,N′-disuccinic acid, ethylenebis(oxyethylenenitrilo)-N,N′-disuccinic acid, glucoheptanoic acid, cysteic acid-N,N-diacetic acid, cysteic acid-N-monoacetic acid, alanine-N-monoacetic acid, N-(3-hydroxysuccinyl) aspartic acid, N-[2-(3-hydroxysuccinyl)]-L-serine, aspartic acid-N,N-diacetic acid, aspartic acid-N-monoacetic acid, any salt thereof, or any combination thereof.

Without limitation, the acidic treatment fluids may optionally further comprise any number of additional additives commonly used in acidic treatment fluids including, for example, surfactants, gel stabilizers, anti-oxidants, polymer degradation prevention additives, relative permeability modifiers, scale inhibitors, corrosion inhibitors, foaming agents, defoaming agents, antifoaming agents, emulsifying agents, de-emulsifying agents, iron control agents, proppants or other particulates, particulate diverters, salts, acids, fluid loss control additives, gas, catalysts, clay control agents, dispersants, flocculants, scavengers (e.g., H₂S scavengers, CO₂ scavengers or O₂ scavengers), gelling agents, lubricants, breakers, friction reducers, bridging agents, viscosifiers, weighting agents, solubilizers, pH control agents (e.g., buffers), hydrate inhibitors, consolidating agents, bactericides, catalysts, clay stabilizers, antisludging agents, and the like. Combinations of these additives can be used as well.

The acidic treatment fluids may be used in a variety of acidizing operations in subterranean formations, which may include remedial operations. A method may comprise introducing an acidic treatment fluid into a subterranean formation, wherein the acidic treatment fluid comprises a carrier fluid, an acid compound, a zwitterionic compound, and an anionic compound. By way of example, the acidizing treatment fluids may be used in acid fracturing operations, wherein the acidizing treatment fluid is introduced into the subterranean formation at or above the fracturing pressure such that one or more fractures are created in the subterranean formation. The acid compound in the acidizing treatment fluid may interact with the subterranean formation to solubilize acid-soluble portions of the subterranean formation. In this way, the acidizing treatment fluid may dissolve acid-soluble components of the subterranean formation such that flow paths may be created in the subterranean formation, thereby increasing the rate of hydrocarbon production from the subterranean formation. The acidizing treatment fluid may be introduced into the subterranean formation below the fracturing pressure (e.g., at matrix flow rates) or above the fracturing pressure as desired for a particular application. The zwitterionic compound and the anionic compound in the acidizing treatment fluid may inhibit precipitates that would otherwise form due to the acidizing operation.

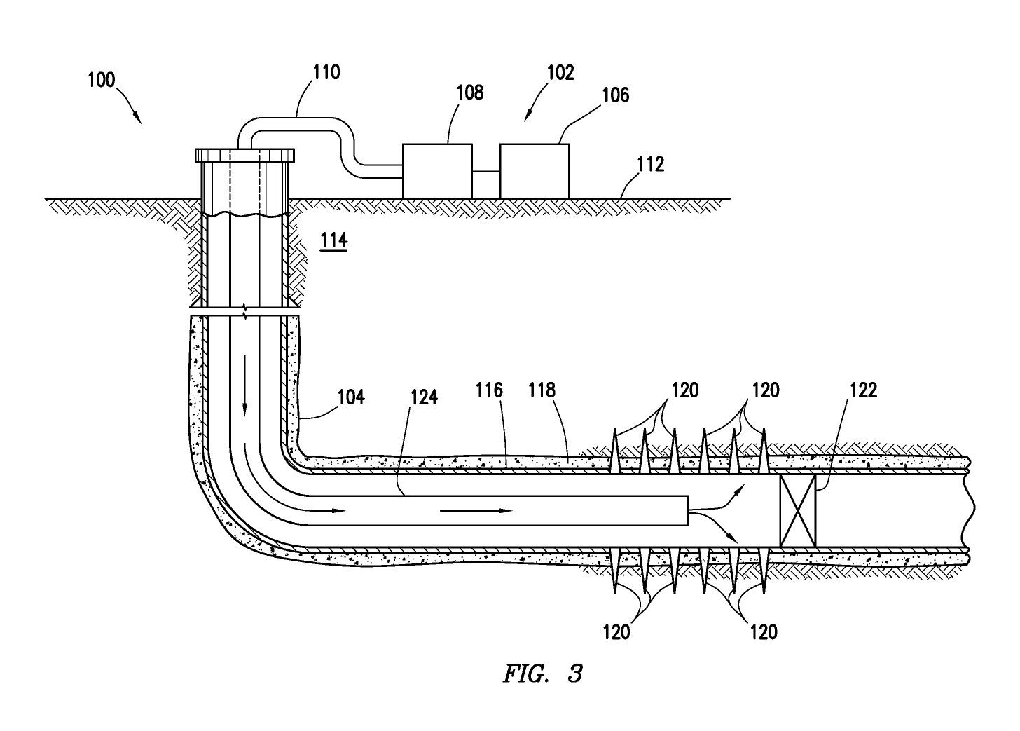

Example methods of using the acidic treatment fluids described herein will now be described in more detail with reference to FIG. 3. Any of the previous examples of the acidic treatment fluids may apply in the context of FIG. 3. FIG. 3 illustrates an example well system 100 that may be used for preparation and delivery of a treatment fluid downhole. It should be noted that while FIG. 3 generally depicts a land-based operation, those skilled in the art will readily recognize that the principles described herein are equally applicable to subsea operations that employ floating or sea-based platforms and rigs, without departing from the scope of the disclosure.

Referring now to FIG. 3, a fluid handling system 102 is illustrated. The fluid handling system 102 may be used for preparation of an acidic treatment fluid comprising a carrier fluid, an acid compound, a zwitterionic compound, and an anionic compound for introduction of the acidic treatment fluid into a wellbore 104. The fluid handling system 102 may include mobile vehicles, immobile installations, skids, hoses, tubes, fluid tanks or reservoirs, pumps, valves, and/or other suitable structures and equipment. As illustrated, the fluid handling system 102 may comprise a fluid supply vessel 106, pumping equipment 108, and wellbore supply conduit 110. While not illustrated, the fluid supply vessel 106 may contain one or more components of the acidic treatment fluid (e.g., carrier fluid, acid compound, etc.) in separate tanks or other containers that may be mixed at any desired time. Pumping equipment 108 may be fluidically coupled with the fluid supply vessel 106 and wellbore supply conduit 110 to communicate the treatment fluid into wellbore 104. Fluid handling system 102 may also include surface and downhole sensors (not shown) to measure pressure, rate, temperature and/or other parameters of treatment. Fluid handling system 102 may also include pump controls and/or other types of controls for starting, stopping, and/or otherwise controlling pumping as well as controls for selecting and/or otherwise controlling fluids pumped during the injection treatment. An injection control system may communicate with such equipment to monitor and control the injection of the treatment fluid. As depicted in FIG. 3, the fluid supply vessel 106 and pumping equipment 108 may be above the surface 112 while the wellbore 104 is below the surface 112. As will be appreciated by those of ordinary skill in the art, well system 100 may be configured as shown in FIG. 2 or in a different manner, and may include additional or different features as appropriate. By way of example, fluid handling system 102 may be deployed via skid equipment, marine vessel, or may be comprised of sub-sea deployed equipment.

Without continued reference to FIG. 3, well system 100 may be used for introduction of the acidic treatment fluid into wellbore 104. Generally, wellbore 104 may include horizontal, vertical, slanted, curved, and other types of wellbore geometries and orientations. Without limitation, the acidic treatment fluid may be applied through the wellbore 104 to subterranean formation 114 surrounding any portion of wellbore 104. As illustrated, the wellbore 104 may include a casing 116 that may be cemented (or otherwise secured) to wellbore wall by cement sheath 118. Perforations 120 allow the treatment fluid and/or other materials to flow into and out of the subterranean formation 114. A plug 122, which may be any type of plug (e.g., bridge plug, etc.) may be disposed in wellbore 104 below the perforations 120 if desired. While FIG. 3 illustrates used of acidic treatment fluid in a cased section of wellbore 104, it should be understood that acidic treatment fluid may also be used in portions of wellbore 104 that are not cased.

The acidic treatment fluid may be pumped from fluid handling system 102 down the interior of casing 116 in wellbore 104. As illustrated, well conduit 124 (e.g., coiled tubing, drill pipe, etc.) may be disposed in casing 116 through which the acidic treatment fluid may be pumped. The well conduit 124 may be the same or different than the wellbore supply conduit 110. For example, the well conduit 124 may be an extension of the wellbore supply conduit 110 into the wellbore 104 or may be tubing or other conduit that is coupled to the wellbore supply conduit 110. The acidic treatment fluid may be allowed to flow down the interior of well conduit 124, exit the well conduit 124, and finally enter subterranean formation 114 surrounding wellbore 104 by way of perforations 120 through the casing 116 (if the wellbore is cased as in FIG. 3) and cement sheath 118. Without limitation, the acidic treatment fluid may be introduced into subterranean formation 114 at matrix flow rates (e.g., below the fracturing pressure) or above the fracturing pressure. By way of example, the acidic treatment fluid may be introduced into the subterranean formation above the fracturing pressure whereby one or more fractures (not shown) may be created or enhanced in subterranean formation 114.

The exemplary acidic treatment fluid disclosed herein may directly or indirectly affect one or more components or pieces of equipment associated with the preparation, delivery, recapture, recycling, reuse, and/or disposal of the amaranth grain particulates. For example, the acidic treatment fluid may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the sealant composition. The acidic treatment fluid may also directly or indirectly affect any transport or delivery equipment used to convey the acidic treatment fluid to a well site or downhole such as, for example, any transport vessels, conduits, pipelines, trucks, tubulars, and/or pipes used to compositionally move the acidic treatment fluid from one location to another, any pumps, compressors, or motors (e.g., topside or downhole) used to drive the acidic treatment fluid into motion, any valves or related joints used to regulate the pressure or flow rate of the acidic treatment fluid, and any sensors (i.e., pressure and temperature), gauges, and/or combinations thereof, and the like. The disclosed acidic treatment fluid may also directly or indirectly affect the various downhole equipment and tools that may come into contact with the acidic treatment fluid such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Accordingly, this disclosure describes systems, compositions, and methods that may be used for inhibition of precipitation during acidizing operations. Without limitation, the systems, compositions and methods may further be characterized by one or more of the following statements:

Statement 1: A method comprising: introducing an acidic treatment fluid into a subterranean formation; wherein the acidic treatment fluid comprises a carrier fluid, an acid compound, a zwitterionic compound, and an anionic compound; wherein the acid compound interacts with the subterranean formation to dissolve acid-soluble components of the subterranean formation; and wherein the zwitterionic compound and the anionic compound inhibit formation of silica scale.

Statement 2: The method of statement 1, further comprising: allowing the anionic compound and the zwitterionic compound to chelate alkali metal ions.

Statement 3: The method of statement 1 or 2, further comprising: preparing the acidic treatment fluid in a fluid handling system; and pumping the acidic treatment fluid from the fluid handling system and into a wellbore that penetrates the subterranean formation.

Statement 4: The method of any one of statements 1 to 3, wherein the subterranean formation comprises a sandstone formation.

Statement 5: The method of any one of statements 1 to 4, wherein the acidic treatment fluid has a pH of about 6 or less.

Statement 6: The method of any one of statements 1 to 5, wherein the zwitterionic compound comprises a zwitterionic polysaccharide, wherein the zwitterionic polysaccharide comprises a positively charged free amino moiety and a negatively charged moiety comprising at least one group selected from the group consisting of carboxylate, phosphate, phosphonate, sulfate, sulfonate, and combinations thereof.

Statement 7: The method of any one of statements 1 to 6, wherein the zwitterionic compound comprises a zwitterionic chitosan.

Statement 8: The method of any one of statements 1 to 7, wherein the anionic compound comprises at least one anionic compound selected from the group consisting of organic acid, anionic carboxylated polysaccharides, and combinations thereof.

Statement 9: The method of any one of statements 1 to 8, wherein the anionic compound comprises an anionic carboxylated fructan.

Statement 10: The method of any one of statements 1 to 9, wherein the anionic compound comprises anionic carboxymethyl inulin, and wherein the zwitterionic compound comprises zwitterionic phosphonated chitosan.

Statement 11: The method of any one of statements 1 to 10, wherein the acid compound comprises at least one material selected from the group consisting of an acid, an acid-generating compound, and combinations thereof.

Statement 12: The method of any one of statements 1 to 11, wherein the acid compound comprises hydrochloric acid and hydrofluoric acid.

Statement 13: An acidic treatment fluid comprising: a carrier fluid; an acid compound; a zwitterionic compound; and an anionic compound.

Statement 14: The acidic treatment fluid of statement 13, wherein the acidic treatment fluid has a pH of about 6 or less.

Statement 15: The acidic treatment fluid of statement 13 or 14, wherein the zwitterionic compound comprises a zwitterionic polysaccharide, wherein the zwitterionic polysaccharide comprises a positively charged free amino moiety and a negatively charged moiety comprising at least one group selected from the group consisting of carboxylate, phosphate, phosphonate, sulfate, sulfonate, and combinations thereof.

Statement 16: The acidic treatment fluid of any one of statements 13 to 15, wherein the anionic compound comprises at least one anionic compound selected from the group consisting of organic acid, anionic carboxylated polysaccharides, and combinations thereof.

Statement 17: The acidic treatment fluid of any one of statements 13 to 16, wherein the anionic compound comprises anionic carboxymethyl inulin, wherein the zwitterionic compound comprises zwitterionic phosphonated chitosan, and wherein the acid compound comprises hydrochloric acid and hydrofluoric acid.

Statement: 18: The acidic treatment fluid of statement 13 further comprising one or more of the features defined in any one of statements 5 to 12.

Statement 19: A well system comprising: an acidic treatment fluid comprising a carrier fluid, an acid compound, a zwitterionic compound, and an anionic compound; a fluid handling system comprising the acidic treatment fluid; and a conduit fluidically coupled to the fluid handling system and a wellbore.

Statement 20: The well system of statement 19, wherein the fluid handling system comprises a fluid supply and pumping equipment.

Statement 21: The well system of statement 19 or 20, wherein the anionic compound comprises anionic carboxymethyl inulin, wherein the zwitterionic compound comprises zwitterionic phosphonated chitosan, and wherein the acid compound comprises hydrochloric acid and hydrofluoric acid.

Statement 22: The well system of statement 19 or 20, further comprising one or more of the features defined in any one of statements 5 to 12.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method comprising:
introducing an acidic treatment fluid into a subterranean formation;
wherein the acidic treatment fluid comprises a carrier fluid, an acid compound, a zwitterionic compound, and an anionic compound;
wherein the acid compound interacts with the subterranean formation to dissolve acid-soluble components of the subterranean formation; and
wherein the zwitterionic compound and the anionic compound inhibit formation of silica scale.

2. The method of claim 1, further comprising: allowing the anionic compound and the zwitterionic compound to chelate alkali metal ions.

3. The method of claim 1, further comprising: preparing the acidic treatment fluid in a fluid handling system; and pumping the acidic treatment fluid from the fluid handling system and into a wellbore that penetrates the subterranean formation.

4. The method of claim 1, wherein the subterranean formation comprises a sandstone formation.

5. The method of claim 1, wherein the acidic treatment fluid has a pH of about 6 or less.

6. The method of claim 1, wherein the zwitterionic compound comprises a zwitterionic polysaccharide, wherein the zwitterionic polysaccharide comprises a positively charged free amino moiety and a negatively charged moiety comprising at least one group selected from the group consisting of carboxylate, phosphate, phosphonate, sulfate, sulfonate, and combinations thereof.

7. The method of claim 1, wherein the zwitterionic compound comprises a zwitterionic chitosan.

8. The method of claim 1, wherein the anionic compound comprises at least one anionic compound selected from the group consisting of organic acid, anionic carboxylated polysaccharides, and combinations thereof.

9. The method of claim 1, wherein the anionic compound comprises an anionic carboxylated fructan.

10. The method of claim 1, wherein the anionic compound comprises anionic carboxymethyl inulin, and wherein the zwitterionic compound comprises zwitterionic phosphonated chitosan.

11. The method of claim 1, wherein the acid compound comprises at least one material selected from the group consisting of an acid, an acid-generating compound, and combinations thereof.

12. The method of claim 1, wherein the acid compound comprises hydrochloric acid and hydrofluoric acid.

13. An acidic treatment fluid comprising:
a carrier fluid;
an acid compound;
a zwitterionic compound; and
an anionic compound.

14. The acidic treatment fluid of claim 13, wherein the acidic treatment fluid has a pH of about 6 or less.

15. The acidic treatment fluid of claim 13, wherein the zwitterionic compound comprises a zwitterionic polysaccharide, wherein the zwitterionic polysaccharide comprises a positively charged free amino moiety and a negatively charged moiety comprising at least one group selected from the group consisting of carboxylate, phosphate, phosphonate, sulfate, sulfonate, and combinations thereof.

16. The acidic treatment fluid of claim 13, wherein the anionic compound comprises at least one anionic compound selected from the group consisting of organic acid, anionic carboxylated polysaccharides, and combinations thereof.

17. The acidic treatment fluid of claim 13, wherein the anionic compound comprises anionic carboxymethyl inulin, wherein the zwitterionic compound comprises zwitterionic phosphonated chitosan, and wherein the acid compound comprises hydrochloric acid and hydrofluoric acid.

18. A well system comprising
An acidic treatment fluid comprising a carrier fluid, an acid compound, a zwitterionic compound, and an anionic compound;
a fluid handling system comprising the acidic treatment fluid; and
a conduit fluidically coupled to the fluid handling system and a wellbore.

19. The well system of claim 18, wherein the fluid handling system comprises a fluid supply and pumping equipment.

20. The well system of claim 18, wherein the anionic compound comprises anionic carboxymethyl inulin, wherein the zwitterionic compound comprises zwitterionic phosphonated chitosan, and wherein the acid compound comprises hydrochloric acid and hydrofluoric acid.
